(19) United States
(12) Patent Application Publication
(10) Pub. No.: US 2009/0301394 A1
(43) Pub. Date: Dec. 10, 2009

(54) FILM COATING HOLDER

(75) Inventor: Chung-Pei WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/327,553

(22) Filed: Dec. 3, 2008

(30) Foreign Application Priority Data
Jun. 5, 2008 (CN) 200810302041.0

(51) Int. Cl. B05C 13/02

(52) U.S. Cl. 118/500

(57) ABSTRACT

A film coating holder includes a rotating shaft having a first portion and a second portion, a plurality of connecting devices, and a plurality of workpiece holders mounted around the rotating shaft. Each of the workpiece holders includes a relative big-end and a relative small-end. The relative small-end of each workpiece holder is pivotally connected to the first portion of the rotating shaft. The relative big-end of each workpiece holder is pivotally connected to the second portion of the rotating shaft via respective connecting devices.

### CROSS REFERENCE TO RELATED APPLICATION

This application is related to commonly-assigned copending application Ser. No. 12/181,157, entitled “FILM COATING HOLDER AND FILM COATING DEVICE USING SAME” (attorney docket number US 15511). Disclosures of the above-identified application are incorporated herein by reference.

### BACKGROUND

1. Field of the Invention

The present invention relates to a film coating holder.

2. Description of Related Art

Generally, in a film coating process for workpieces (e.g., lenses), the workpieces are placed on a film coating holder. Referring FIG. 6, a typical film coating holder includes a rotating shaft 4 and an umbrella-shaped workpiece holder 3. The workpiece holder 3 is a single body, which limits the coating area and coating precision of the coating process.

Therefore, a new film coating holder is desired to overcome the shortcomings described above.

### SUMMARY

A film coating holder includes a rotating shaft having a first portion and a second portion, a plurality of connecting devices, and a plurality of workpiece holders mounted around the rotating shaft. Each of the workpiece holders includes a relative big-end and a relative small-end. The relative small-end of each workpiece holder is pivotally connected to the first portion of the rotating shaft. The relative big-end of each workpiece holder is pivotally connected to the second portion of the rotating shaft via respective connecting devices.

### BRIEF DESCRIPTION OF THE DRAWINGS

FIG. 1 is an isometric view of a film coating holder in accordance with a first embodiment, the film coating holder including a connecting device.

FIG. 2 is an isometric view of the connecting device in FIG. 1.

FIG. 3 is a cross-sectional view taken along line III-III of FIG. 1.

FIG. 4 is a cross-sectional view of a film coating holder in accordance with a second embodiment.

FIG. 5 is a cross-sectional view of a film coating holder in accordance with a third embodiment.

FIG. 6 is an isometric view of a conventional film coating holder.

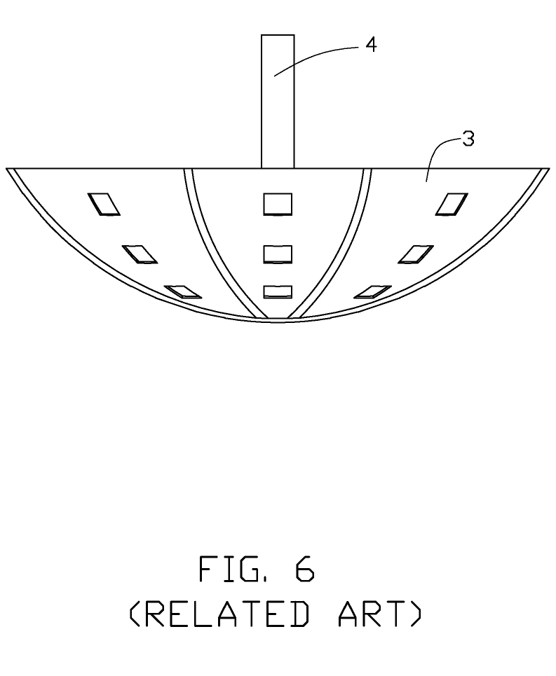

### DETAILED DESCRIPTION

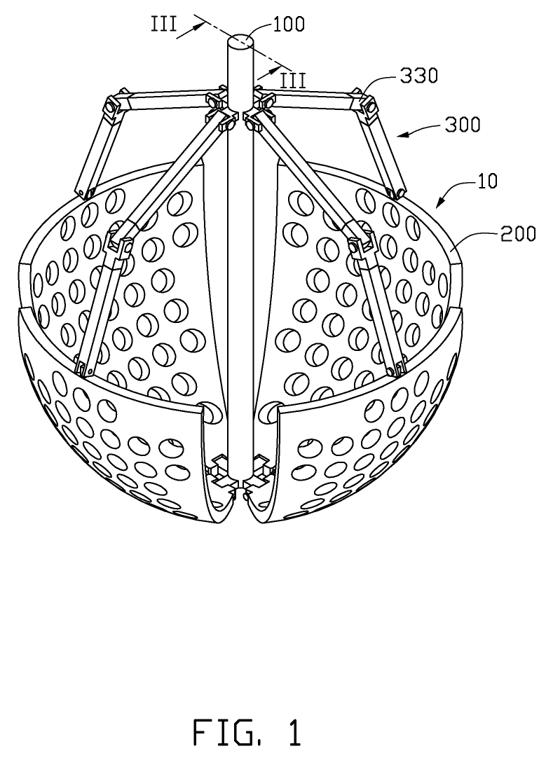

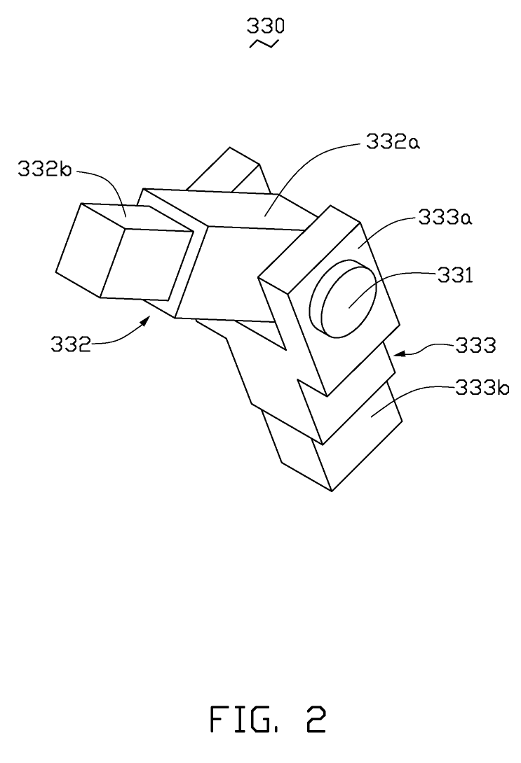

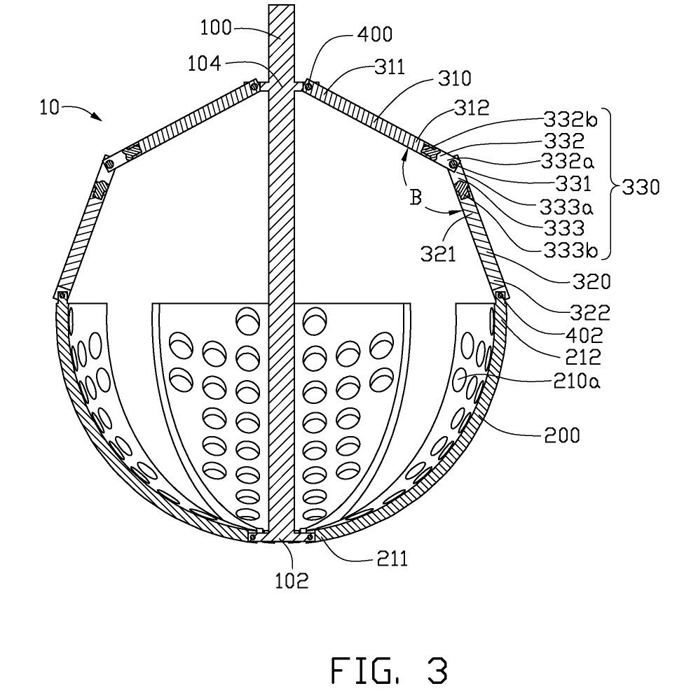

Referring to FIGS. 1 to 3, a film coating holder 10 according to the first embodiment includes a rotating shaft 100, a plurality of workpiece holders 200, and a plurality of connecting devices 330 interconnected between the rotating shaft 100 and the respective workpiece holders 200. The rotating shaft 100 and the workpiece holders 200 are made of a high thermally conductive metallic material, such as copper, aluminum, or stainless steel.

In the first embodiment, the film coating holder 10 is umbrella-shaped. Each of the workpiece holders 200 is sector-shaped and axisymmetrical. A relative small-end 211 of each workpiece holder 200 is pivotally connected to a first portion 102 of the rotating shaft 100, and a relative big-end 212 of each workpiece holder 200 is connected to a second portion 104 of the rotating shaft 100 via the respective connecting device 330. Each workpiece holder 200 defines a number of through holes 210a for receiving workpieces (not shown).

Each of the connecting device 330 includes a first rod 310, a second rod 320 and a connector 330. The connector 330 includes an angle correcting device 331, a first elongated connecting portion 332, and a second elongated connecting portion 333. The angle correcting device 331 can be a goniometer. The first elongated connecting portion 332 includes a first end 332a and a second end 332b. The second elongated connecting portion 333 includes a first end 333a and a second end 333b. The first end 332a of the first connecting porting 332 is connected with the first end 333a of the second elongated connecting portion 333 via the angle correcting device 331. The angle correcting device 331 is configured for adjusting an angle B between the first elongated connecting portion 332 and the second elongated connecting portion 333.

In the first embodiment, a first end 311 of the first rod 310 is connected to the second portion 104 of the rotating shaft 100 by a pivot 400. A second end 312 of the first rod 310 is rabbet on the second end 332b of the first elongated connecting portion 332. A first end 321 of the second rod 320 is rabbet on the second end 333b of the second elongated connecting portion 333. A second end 322 of the second rod 320 is pivotally connected with the relative big-end 212 of the workpiece holder 200 via a third pivot 402.

The angle B between the first elongated connecting portion 332 and the second elongated connecting portion 333 can be adjusted by rotating the angle correcting device 331. When the angle B is changed, the first rod 310 and the second rod 320 are driven by the connector 330 to respectively rotate around the pivot 400 and the third pivot 402. The rotating movement of the first rod 310 and the second rod 320 causes movement of the workpiece holder 200. Thus, the position of each of the workpiece holder 200 can be adjusted.

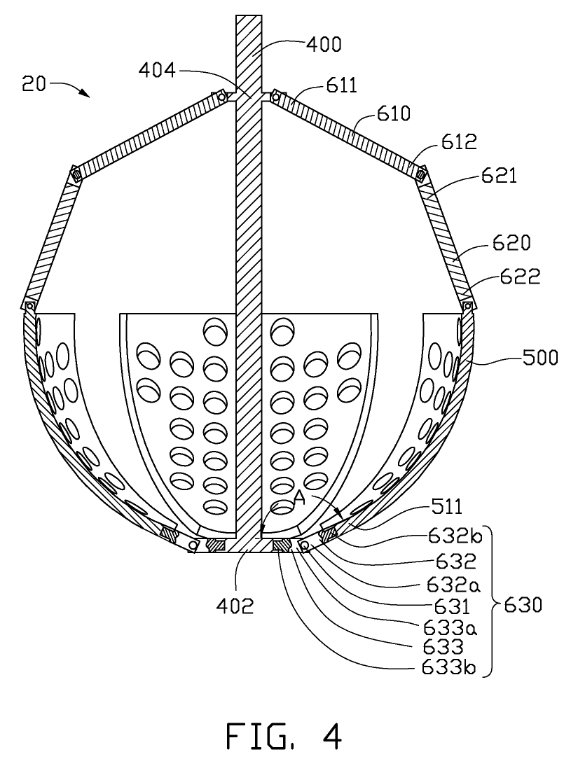

Referring to FIG. 4, a film coating holder 20 according to the second embodiment includes a rotating shaft 400, a plurality of workpiece holders 500, a first rod 610 and a second rod 620. The first rod 610 includes a first end 611 and a second end 612. The second rod 620 includes a first end 621 and a second end 622. The first end 611 is pivotally connected to a second portion 404 of the rotating shaft 400, and the second end 612 is pivotally connected to the first end 621.

In the second embodiment, each of the workpiece holders 500 is connected with the first portion 402 of the rotating shaft 400 via a connecting device 630. The connecting device 630 includes an angle correcting device 631, a first elongated connecting portion 632, and a second elongated connecting portion 633. The angle correcting device 631 can be a goniometer. The first elongated connecting portion 632 includes a first end 632a and a second end 632b. The second elongated connecting portion 633 includes a first end 633a and a second end 633b. The first end 632a of the first connecting porting 632 is connected with the first end 633a of the second elongated connecting portion 633 via the angle correcting device 631. The angle correcting device 631 is configured for adjusting an angle A between the first elongated connecting portion 632 and the second elongated connecting portion 633.

A relative small-end 511 of each of the workpiece holders 500 is rabbet on the second end 632b of the first elongated connecting portion 632. The second end 633b of the second elongated connecting portion 633 is rabbet on the first portion 402 of the rotating shaft 400.

The angle A between the first elongated connecting portion 632 and the second elongated connecting portion 633 can be adjusted by rotating the angle correcting device 631. When the angle A is adjusted, the position of the workpiece holder 500 is correspondingly adjusted. The position of other workpiece holders 200 can also be adjusted through this way.

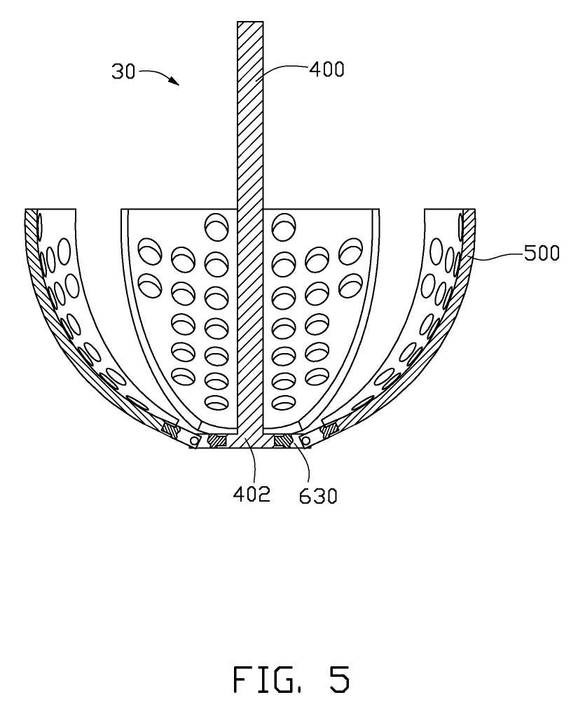

Referring to FIG. 5, a film coating holder 30 according to the third embodiment is illustrated. The structure of the holder 30 is similar with that of the holder 20 in the second embodiment. The difference between the film coating holder 30 and the film coating holder 20 in the second embodiment is that each of the workpiece holder 500 is connected with the first portion 402 of the rotating shaft 400 only via the connecting device 630, the first rod 610 and the second rod 620 are not applied in the film coating holder 30.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A film coating holder comprising:
a rotating shaft having a first portion and a second portion;
a plurality of connecting devices; and a plurality of workpiece holders mounted around the rotating shaft, each of the workpiece holders comprising a relative big-end and a relative small-end, the relative small-end of each workpiece holder being pivotally connected to the first portion of the rotating shaft, and the relative big-end of each workpiece holder being pivotally connected to the second portion of the rotating shaft via respective connecting devices.

2. The film coating holder of claim 1, wherein the connecting device comprises a first rod, a second rod, and a connector mounted between the first rod and the second rod, the first rod is pivotally connected to the second portion of the rotating shaft, and the second rod is pivotally connected to the relative big-end of the workpiece holder.

3. The film coating holder of claim 2, wherein the connector comprises a first elongated connecting portion, a second elongated connecting portion, and an angle correcting device mounted between the first elongated connecting portion and the second elongated connecting portion, the first elongated connecting portion is connected to the first rod, and the second elongated connecting portion is connected to the second rod.

4. The film coating holder of claim 3, wherein the angle correcting device is a goniometer.

5. A film coating holder comprising:
a rotating shaft having a first portion;
a plurality of connecting devices; and
a plurality of workpiece holders mounted around the rotating shaft, each of the workpiece holders comprising a relative big-end and a relative small-end, the relative small-end of each workpiece holder being pivotally connected to the first portion of the rotating shaft via respective connecting devices.

6. The film coating holder of claim 5, wherein the connecting device comprises a first rod, a second rod, and a connector mounted between the first rod and the second rod, the first rod is pivotally connected to the second portion of the rotating shaft, and the second rod is pivotally connected to the relative big-end of the workpiece holder.

7. The film coating holder of claim 6, wherein the connector comprises a first elongated connecting portion, a second elongated connecting portion, and an angle correcting device mounted between the first elongated connecting portion and the second elongated connecting portion, the first elongated connecting portion is connected to the first rod, and the second elongated connecting portion is connected to the second rod.

8. The film coating holder of claim 7, wherein the angle correcting device is a goniometer.
